(19) United States
(12) Patent Application Publication
(10) Pub. No.: US 2008/0120273 A1
(43) Pub. Date: May 22, 2008

(54) Profile based optimization

(76) Inventors: Bhashyam Ramesh, Secunderabad (IN); Michael Warren Watzke, Madison, WI (US)

Correspondence Address: JAMES M. STOVER;TERADATA CORPORATION, 2835 MIAMI VILLAGE DRIVE, MIAMISBURG, OH, 45342, US

(21) Appl. No.: 11/600,653

(22) Filed: Nov. 16, 2006

(51) Int. Cl. G06F 7/00

(52) U.S. Cl. 707/2

(57) ABSTRACT

A method, computer program, and system for optimizing the execution of a SQL request on a database system are disclosed. The database system has a state. The request has characteristics and the state has characteristics. The SQL request is parsed to create a logical plan. The logical plan is enumerated into a plurality of physical plans. The plurality of physical plans are costed using current environmental and data demographics of the database system to produce cost information. One of the plurality of physical plans is selected using the cost information and workload profile information to execute the request. Workload profile information includes one or more characteristics of the request and the state of the database system. The request is executed using the selected physical plan to produce results.

### CROSS REFERENCE TO RELATED APPLICATIONS

This application is related to U.S. patent application Ser. No. 10/730,348, filed Dec. 8, 2003, entitled Administering the Workload of a Database System Using Feedback, by Douglas P. Brown, Anita Richards, Bhashyam Ramesh, Caroline M. Ballinger and Richard D. Glick, NCR Docket No. 11167; this application is related to U.S. patent application Ser. No. 10/786,448, filed Feb. 25, 2004, entitled Guiding the Development of Workload Group Definition Classifications, by Douglas P. Brown, Bhashyam Ramesh and Anita Richards, NCR Docket No. 11569; this application is related to U.S. patent application Ser. No. 10/889,796, filed Jul. 13, 2004, entitled Administering Workload Groups, by Douglas P. Brown, Anita Richards, and Bhashyam Ramesh, NCR Docket No. 11560; this application is related to U.S. patent application Ser. No. 10/915,609, filed Jul. 13, 2004, entitled Regulating the Workload of a Database System, by Douglas P. Brown, Bhashyam Ramesh, and Anita Richards, NCR Docket No. 11561; this application is related to U.S. patent application Ser. No. 11/254,374, filed Oct. 20, 2005, entitled Identifying Database Request Sources, by Douglas P. Brown, Anita Richards, and Bhashyam Ramesh, NCR Docket No. 11650; this application is related to U.S. patent application Ser. No. 11/295,409, filed Dec. 6, 2005, entitled A Closed-Loop Supportability Architecture, by Douglas P. Brown, Anita Richards, and Bhashyam Ramesh, NCR Docket No. 11651; this application is related to U.S. patent application Ser. No. 11/334,615, filed Jan. 18, 2006, entitled A Closed-Loop Validator, by Douglas P. Brown, Anita Richards, and Bhashyam Ramesh, NCR Docket No. 11654; this application is related to U.S. patent application Ser. No. 11/435,523, filed May 17, 2006, entitled Managing Database Utilities to Improve Throughput and Concurrency, by Anita Richards, Douglas P. Brown, Bruce Wayne Britton, and Todd A. Walter, NCR Docket No. 11646.

### BACKGROUND

When executing a request (e.g., a query or a utility), a database processing system often has more than one processing plan that it can follow. The database processing system typically uses an optimizer to choose the best processing plan. Traditionally, the optimizer chooses the lowest cost plan. In a database processing system that operates on relations (e.g., tables), cost is measured by, for example, the number of output rows in the result, the amount of CPU time that will be consumed by executing the request, the amount of memory that will be consumed by executing the request, etc.

It has also been recognized that semantic information stored in the database as, for example, integrity constraints could be used by the optimizer in choosing the best processing plan. For example, it may be possible to optimize the execution of a query by eliminating a join based on a foreign key constraint. This form of optimization is called semantic query optimization.

### SUMMARY

In general, in one aspect, the invention features a method for optimizing the execution of a SQL request on a database system. The database system has a state. The request has characteristics and the state has characteristics. The method includes parsing the SQL request to create a logical plan, enumerating the logical plan into a plurality of physical plans, costing the plurality of physical plans using current environmental and data demographics of the database system to produce cost information, and selecting one of the plurality of physical plans to execute the request using the cost information and workload profile information. Workload profile information includes one or more characteristics of the request and the state of the database system. The method further includes executing the request using the selected physical plan to produce results.

Implementations of the invention may include one or more of the following. Using the workload profile information may include using characteristics of the request including one or more of the following: (a) service level goals and priorities, and (b) application types. Selecting a plan to execute the request using the workload profile information may include using characteristics of the state of the database system including one or more of the following: (a) memory availability, (b) task availability, (c) disk availability, (d) CPU availability, (e) lock granularity, (f) type of scan that is being run by the system for another request, and (g) request arrival rate. Enumerating the logical plan into a plurality of physical plans may include consideration of one or more of the following types of joins in the request, one or more access paths available for the tables join geographies, and the order of execution of the joins in the request.

In general, in another aspect, the invention features a method for optimizing the execution of a SQL request on a database system. The database system has a state. The SQL request has been parsed to create a logical plan. The logical plan has been enumerated into a plurality of physical plans. Each of the plurality of physical plans has been costed using current environmental and data demographics of the database system to produce cost information. The method includes selecting one of the plurality of physical plans to execute the query using the cost information and workload profile information. Workload profile information includes one or more characteristics of the request and one or more characteristics of the state of the database system.

In general, in another aspect, the invention features a computer program, stored on a tangible storage medium, for use in optimizing the execution of a SQL request on a database system. The database system has a state. The request has characteristics and the state has characteristics. The program includes executable instructions that cause a computer to parse the SQL request to create a logical plan, enumerate the logical plan into a plurality of physical plans, cost the plurality of physical plans using current environmental and data demographics of the database system to produce cost information, and select one of the plurality of physical plans to execute the request using the cost information and workload profile information. Workload profile information includes one or more characteristics of (a) the request and (b) the state of the database system. The program further includes executable instructions that cause the computer to execute the request using the selected physical plan to produce results.

In general, in another aspect, the invention features a computer program, stored on a tangible storage medium, for use in executing a SQL request on a database system. The database system has a state. The request has characteristics and the state has characteristics. The SQL request has been parsed to create a logical plan. The logical plan has been enumerated into a plurality of physical plans. Each of the plurality of physical plans has been costed using current environmental and data demographics of the database system to produce cost information. The program includes executable instructions that cause a computer to select one of the plurality of physical plans to execute the query using the cost information and workload profile information. Workload profile information includes one or more characteristics of the request and the state of the database system.

In general, in another aspect, the invention features a system including a massively parallel processing system including one or more nodes, a plurality of CPUs, each of the one or more nodes providing access to one or more CPUs, a plurality of data storage facilities, each of the one or more CPUs providing access to one or more data storage facilities, and a process for optimizing the execution of a SQL request on a database system. The database system has a state. The state has characteristics and the request has characteristics. The process includes parsing the SQL request to create a logical plan, enumerating the logical plan into a plurality of physical plans, costing the plurality of physical plans using the current environmental and data demographics of the database system to produce cost information, and selecting one of the plurality of physical plans to execute the request using the cost information and workload profile information. Workload profile information includes one or more characteristics of the request and the state of the database system. The process further includes executing the request using the selected physical plan to produce results.

In general, in another aspect, the invention features a system including a massively parallel processing system including one or more nodes, a plurality of CPUs, each of the one or more nodes providing access to one or more CPUs, a plurality of data storage facilities, each of the one or more CPUs providing access to one or more data storage facilities, and a process for optimizing the execution of a SQL request on a database system. The database system has a state. The state has characteristics and the request has characteristics. The SQL request has been parsed to create a logical plan. The logical plan has been enumerated into a plurality of physical plans. Each of the plurality of physical plans has been costed using the current environmental and data demographics of the database system to produce cost information. The method includes selecting one of the plurality of physical plans to execute the query using the cost information; and workload profile information. Workload profile information includes one or more characteristics of the request and the state of the database system.

In general, in another aspect, the invention features a method for optimizing the execution of a SQL request on a database system. The database system has a state. The state has characteristics and the request has characteristics. The method includes parsing the SQL request to create a logical plan, enumerating the logical plan into a plurality of physical plans, costing the plurality of physical plans using the current environmental and data demographics of the database system and workload profile information to produce cost information. Workload profile information includes one or more characteristics of the request and the state of the database system. The method further includes selecting one of the plurality of physical plans to execute the request using the cost information and executing the request using the selected physical plan to produce results.

### BRIEF DESCRIPTION OF THE DRAWINGS

FIG. 1 is a block diagram of a node of a database system.

FIG. 2 is a block diagram of a parsing engine.

FIG. 3 is a block diagram of a parser.

FIGS. 4 and 5 are block diagrams of an example optimizer.

FIG. 6 illustrates the contents of workload profile information.

### DETAILED DESCRIPTION

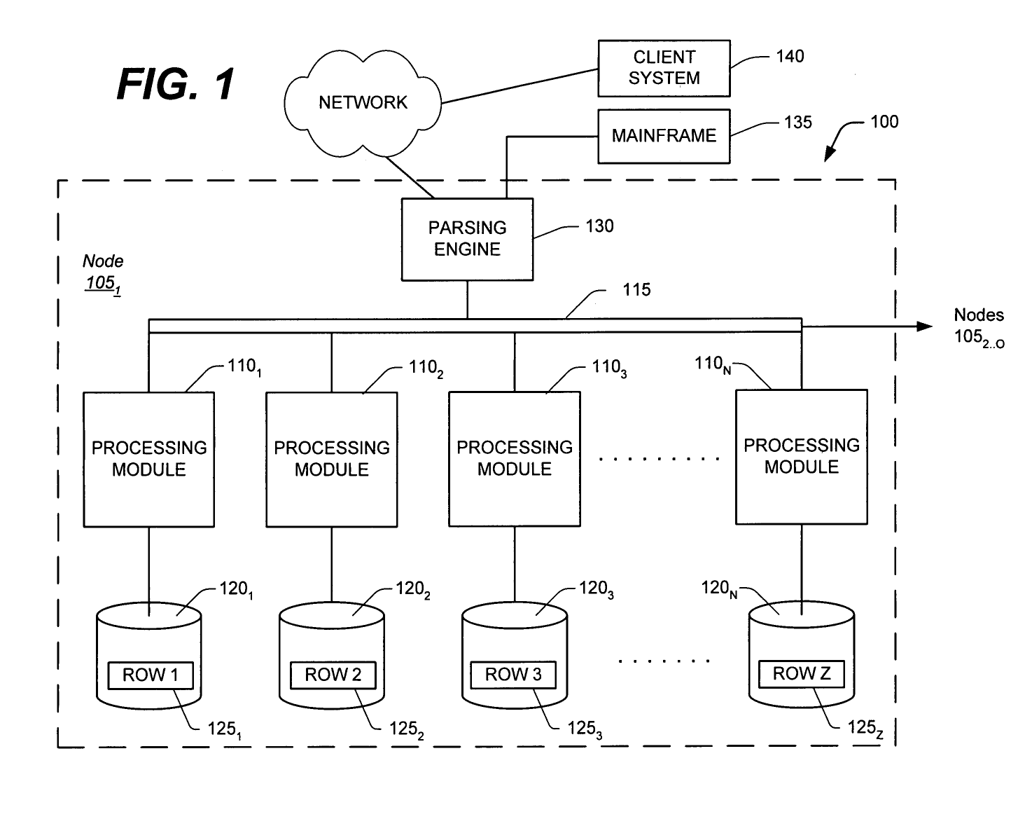

The technique for profile based optimization disclosed herein has particular application, but is not limited, to large databases that might contain many millions or billions of records managed by a database system (“DBMS”) 100, such as a Teradata Active Data Warehousing System available from NCR Corporation. FIG. 1 shows a sample architecture for one node 105₁ of the DBMS 100. The DBMS node 105₁ includes one or more processing modules 110_{1 . . . N}, connected by a network 115, that manage the storage and retrieval of data in data-storage facilities 120_{1 . . . N}. Each of the processing modules 110_{1 . . . N} may be one or more physical processors or each may be a virtual processor, with one or more virtual processors running on one or more physical processors.

For the case in which one or more virtual processors are running on a single physical processor, the single physical processor swaps between the set of N virtual processors.

For the case in which N virtual processors are running on an M-processor node, the node's operating system schedules the N virtual processors to run on its set of M physical processors. If there are 4 virtual processors and 4 physical processors, then typically each virtual processor would run on its own physical processor. If there are 8 virtual processors and 4 physical processors, the operating system would schedule the 8 virtual processors against the 4 physical processors, in which case swapping of the virtual processors would occur.

Each of the processing modules 110_{1 . . . N} manages a portion of a database that is stored in a corresponding one of the data-storage facilities 120_{1 . . . N}. Each of the data-storage facilities 120_{1 . . . N} includes one or more disk drives. The DBMS may include multiple nodes 105_{2 . . . O} in addition to the illustrated node 105₁, connected by extending the network 115.

The system stores data in one or more tables in the data-storage facilities 120_{1 . . . N}. The rows 125_{1 . . . Z} of the tables are stored across multiple data-storage facilities 120_{1 . . . N} to ensure that the system workload is distributed evenly across the processing modules 110_{1 . . . N}. A parsing engine 130 organizes the storage of data and the distribution of table rows 125_{1 . . . Z} among the processing modules 110_{1 . . . N}. The parsing engine 130 also coordinates the retrieval of data from the data-storage facilities 120_{1 . . . N} in response to queries received from a user at a mainframe 135 or a client computer 140. The DBMS 100 usually receives queries and commands to build tables in a standard format, such as SQL.

In one implementation, the rows 125_{1 . . . Z} are distributed across the data-storage facilities 120_{1 . . . N} by the parsing engine 130 in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket”. The hash buckets are assigned to data-storage facilities 120_{1 . . . N} and associated processing modules 110_{1 . . . N} by a hash bucket map. The characteristics of the columns chosen for the primary index determine how evenly the rows are distributed.

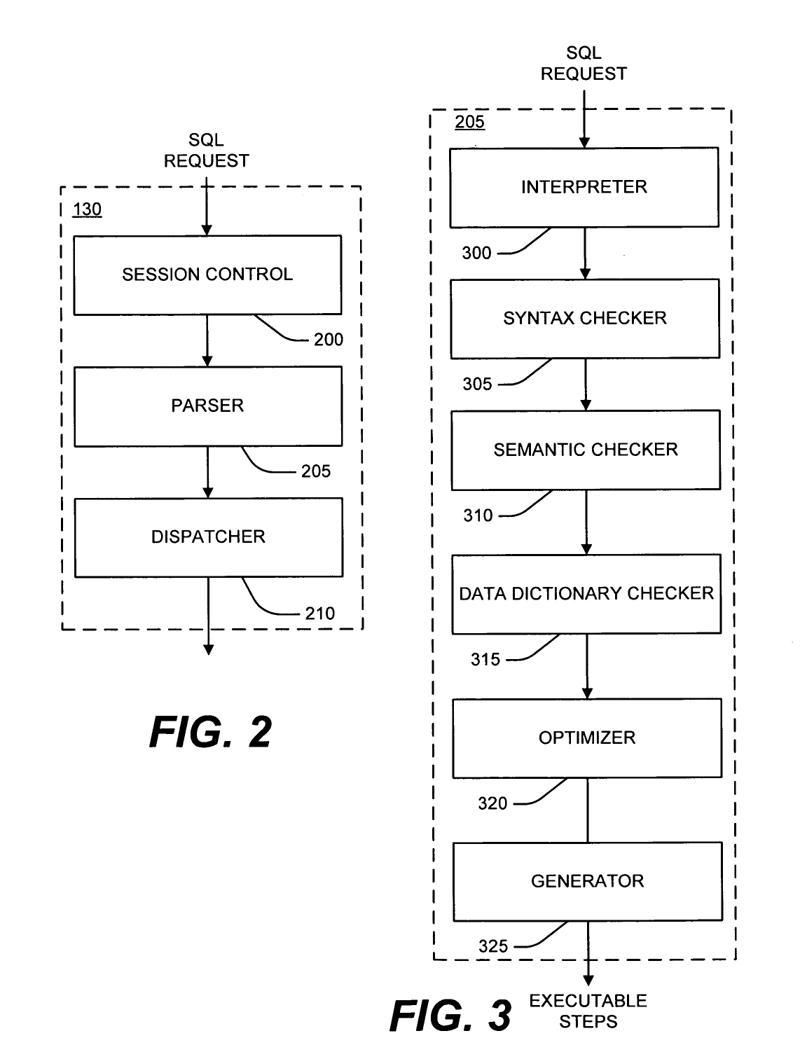

In one example system, the parsing engine 130 is made up of three components: a session control 200, a parser 205, and a dispatcher 210, as shown in FIG. 2. The session control 200 provides the logon and logoff function. It accepts a request for authorization to access the database, verifies it, and then either allows or disallows the access.

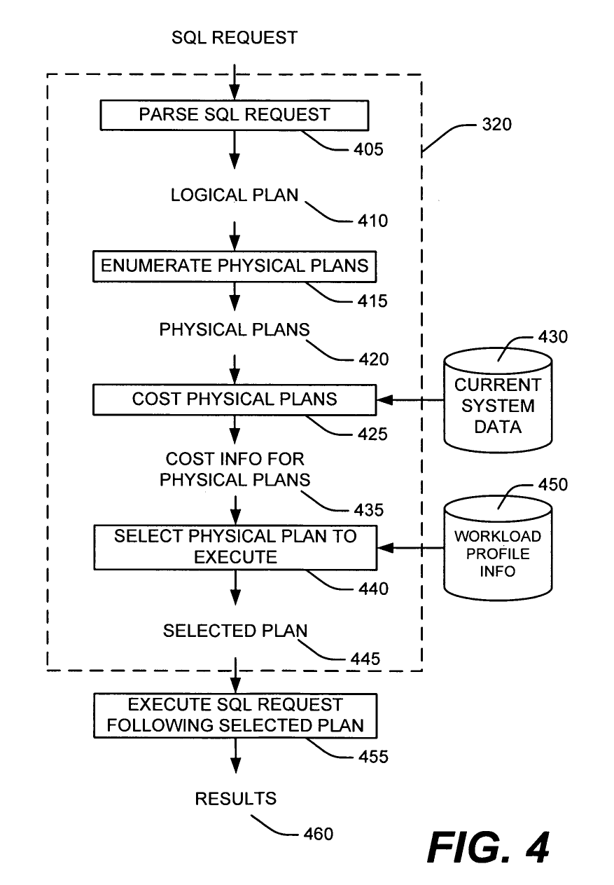

Once the session control 200 allows a session to begin, a user may submit a SQL request, which is routed to the parser 205. As illustrated in FIG. 3, the parser 205 interprets the SQL request (block 300), checks it for proper SQL syntax (block 305), evaluates it semantically (block 310), and consults a data dictionary to ensure that all of the objects specified in the SQL request actually exist and that the user has the authority to perform the request (block 315). Finally, the parser 205 runs an optimizer (block 320), which generates the least expensive plan to perform the request.

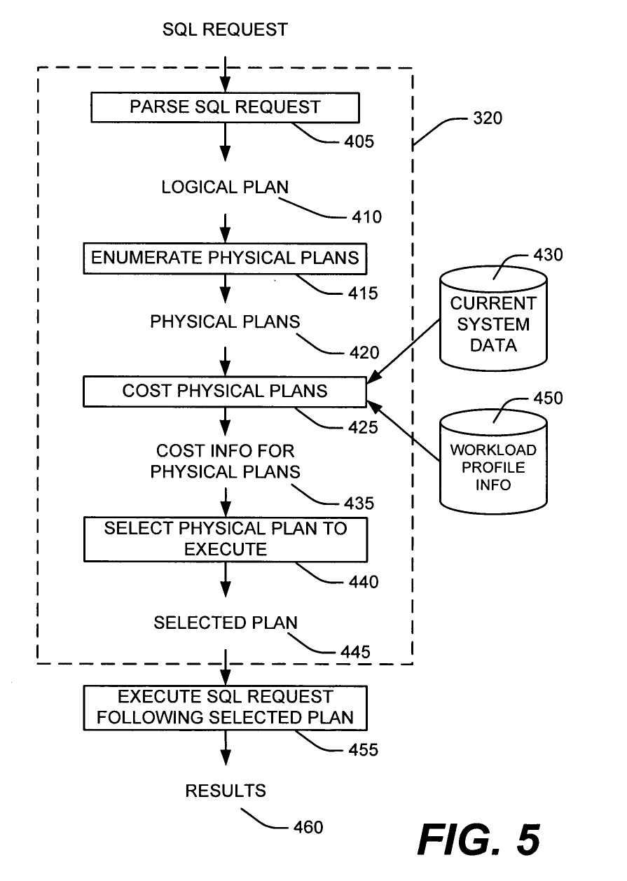

The optimizer (block 320) performs a number of processes, examples of which are illustrated in FIG. 4. It may first parses the SQL request (block 405) to create a logical plan 410. It may then enumerate the logical plan (block 415) to produce a plurality of physical plans 420. The enumeration occurs to account for, for example, different types of joins (merge, hash, product, nested, etc.), access paths (table scan, index, ppi, etc.), join geographies (redistribute, duplicate, local, etc.), join orders (a join b then join c or a join c then b, etc.), etc.

In addition, as part of enumerating the logical plan the optimizer (block 320) may rewrite some requests to generate additional plan options. For example, semantic optimization can be used to generate plans with a join removed because of a primary key/foreign key (PK/FK) definition in the data model. For example, the following query:
SELECT . . .
FROM A, B, C
WHERE
A.c1=b.c1
AND B.c2=C.c1
   may be rewritten to:
SELECT . . .
FROM A, B
WHERE
A.c1=B.c1

The optimizer (block 320) may cost (block 425) the enumerated physical plans 420 using current system data 430 to produce cost information for the physical plans 435. Traditionally, the current system data includes environmental information (the number of nodes, the number of AMPS, interconnection information, memory, etc.), data demographics (row size, table cardinality, column demographics (skew, unique values, etc.), etc.), and rules/heuristics (join tables in the order they appear in the FROM clause, etc.). Traditionally, the optimizer (block 320) selects (block 440) the lowest cost physical plan using the cost information for the physical plans 435 to produce a selected plan 445.

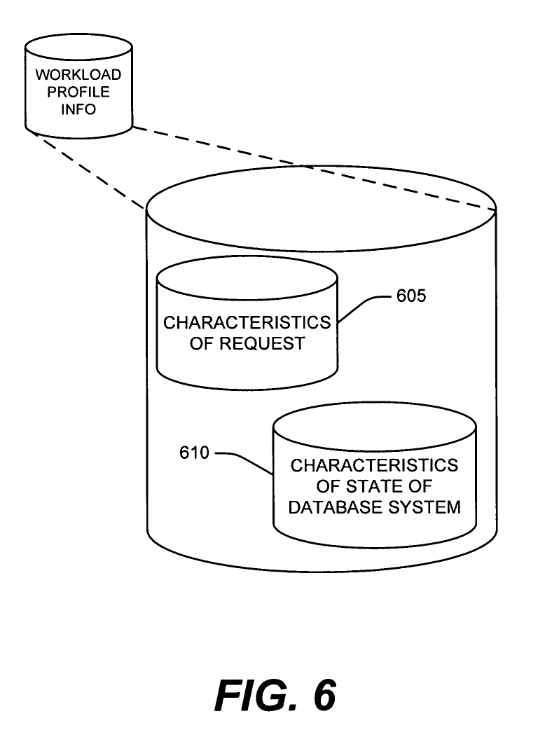

An improved optimizer (block 320) may use workload profile information 450 to refine the cost model and to aid in selecting the physical plan to execute (block 440). Workload profile information 450, illustrated in FIG. 6, may include characteristics of the request 605 and characteristics of the state of the database system 610.

Workload profile information 450 also may be used by a database processing system to manage processing as described in the applications referenced in the “Cross Reference to Related Applications” section set out above. The systems described in those applications use the workload profile information 450 to determine how to apply system resources to received requests based on characteristics of the user (user information) and the request (request information) and based on the availability and status of system resources (system information). This same workload profile information may be used by the optimizer.

Characteristics of the request 605 may include request information and user information. Request information may include one or more of the following: an indication that the request is strategic, and an indication that the request is tactical. As an example of how such information is used in optimization, if a user that normally sends strategic requests sends a tactical request, the optimizer may select a plan that uses fine granular locking at a higher cost over a lower cost plan.

User information may include one or more of the following: user identification, account identification, identification of the application that produced the request, client identification, client address, client profile, and other information about the user. As an example of how such information is used in optimization, the system may receive a request from a user identified in the user information as a tactical user, i.e., a user that needs quick request turnaround. In that case, the optimizer may select a plan that uses fine granular locking at a higher cost over a lower cost plan.

Characteristics of the state of the database system may include one or more of the following: hardware configuration, memory availability, task availability, cache consumption, request arrival rate, skew, blocking, spool, CPU load, input/output load, network load, and other system information. As an example of how such information is used in optimization, if the system is short on disk space, the optimizer may select a physical plan that uses less temporary disk storage over a lower cost plan. As another example, the optimizer may decide that a table scan access join plan is preferable when a synchronized plan is already executing. As another example, if the system is already executing a query by running a sync scan, the optimizer may choose a sync scan over a random access plan for the request under consideration.

Once a plan is selected, the request may be executed following the selected plan (block 450) producing results 455.

In the example approach illustrated in FIG. 4, consideration of the workload profile information occurs after the physical plan costing is done. The cost information for the physical plans 435 may be annotated with information required for workload profiling, such as memory usage, CPU usage, priority, locks, etc. For example, if a request has a high priority, a plan with a fast response time would be favored over one with higher throughput. Or, if the system is low on memory, a hash join would not be selected unless the cost was much better than lower memory consuming plan, where “much better” may be qualified based on the memory available and the relative cost of the plans.

In an alternative approach, illustrated in FIG. 5, the workload profile information 450 is used along with the current system data 430 to cost the physical plans (block 425). In this approach, the cost information and the workload profile information are considered at the same time to produce cost information for the physical plans 435. The lowest cost physical plan is then selected to execute (block 440) resulting in a selected plan 445. The request is then executed following the plan (block 455), producing results 460.

The text above described one or more specific embodiments of a broader invention. The invention also is carried out in a variety of alternative embodiments and thus is not limited to those described here. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for optimizing the execution of a SQL request on a database system, the database system having a state, the request having characteristics and the state having characteristics, the method including:
parsing the SQL request to create a logical plan;
enumerating the logical plan into a plurality of physical plans;
costing the plurality of physical plans using current environmental and data demographics of the database system to produce cost information;
selecting one of the plurality of physical plans to execute the request using:
the cost information; and
workload profile information;
where workload profile information includes one or more characteristics of:
(a) the request; and
(b) the state of the database system;
executing the request using the selected physical plan to produce results.

2. The method of claim 1 where selecting a plan to execute the request using the workload profile information includes:
using characteristics of the request including one or more of the following: (a) service level goals and priorities, and (b) application types.

3. The method of claim 1 where selecting a plan to execute the request using the workload profile information includes:
using characteristics of the state of the database system including one or more of the following:
(a) memory availability, (b) task availability, (c) disk availability, (d) CPU availability, (e) lock granularity, (f) type of scan that is being run by the system for another request, and (g) request arrival rate.

4. The method of claim 1 where enumerating the logical plan into a plurality of physical plans includes consideration of one or more of the following:
types of joins in the request;
one or more access paths available for the tables;
join geographies; and
the order of execution of the joins in the request.

5. A method for optimizing the execution of a SQL request on a database system, the database system having a state, the SQL request having been parsed to create a logical plan, the logical plan having been enumerated into a plurality of physical plans, each of the plurality of physical plans having been costed using current environmental and data demographics of the database system to produce cost information, the method including:
selecting one of the plurality of physical plans to execute the query using:
the cost information; and
workload profile information;
where workload profile information includes one or more characteristics of the request and one or more characteristics of the state of the database system.

6. The method of claim 5 further including:
executing the request using the selected physical plan to produce results.

7. A computer program, stored on a tangible storage medium, for use in optimizing the execution of a SQL request on a database system, the database system having a state, the request having characteristics and the state having characteristics, the program including executable instructions that cause a computer to:
parse the SQL request to create a logical plan;
enumerate the logical plan into a plurality of physical plans;
cost the plurality of physical plans using current environmental and data demographics of the database system to produce cost information;
select one of the plurality of physical plans to execute the request using:
the cost information; and
workload profile information;
where workload profile information includes one or more characteristics of:
(a) the request; and
(b) the state of the database system;
execute the request using the selected physical plan to produce results.

8. The computer program of claim 7 where, when selecting a plan to execute the request using the workload profile information, the computer:
uses characteristics of the request including one or more of the following: (a) service level goals and priorities, and (b) application types.

9. The computer program of claim 7 where, when selecting a plan to execute the request using the workload profile information, the computer:
uses characteristics of the state of the database system including one or more of the following:
(a) memory availability, (b) task availability, (c) disk availability, (d) CPU availability, and (e) lock granularity, (f) type of scan that is being run by the system for another request, and (g) request arrival rate.

10. The computer program of claim 7 where, when enumerating the logical plan into a plurality of physical plans, the computer considers one or more of the following:
types of joins in the request;
one or more access paths available for the tables;
join geographies; and
the order of execution of the joins in the request.

11. A computer program, stored on a tangible storage medium, for use in executing a SQL request on a database system, the database system having a state, the request having characteristics and the state having characteristics, the SQL request having been parsed to create a logical plan, the logical plan having been enumerated into a plurality of physical plans, each of the plurality of physical plans having been costed using current environmental and data demographics of the database system to produce cost information, the program including executable instructions that cause a computer to:
select one of the plurality of physical plans to execute the query using:
the cost information; and
workload profile information;
where workload profile information includes one or more characteristics of the request and the state of the database system.

12. The computer program of claim 11, the program further including executable instructions that cause a computer to:
execute the request using the selected physical plan to produce results.

13. A system including:
a massively parallel processing system including:
one or more nodes;
a plurality of CPUs, each of the one or more nodes providing access to one or more CPUs;
a plurality of data storage facilities, each of the one or more CPUs providing access to one or more data storage facilities;
a process for optimizing the execution of a SQL request on a database system, the database system having a state, the state having characteristics and the request having characteristics, the process including:
parsing the SQL request to create a logical plan;
enumerating the logical plan into a plurality of physical plans;
costing the plurality of physical plans using the current environmental and data demographics of the database system to produce cost information;
selecting one of the plurality of physical plans to execute the request using:
the cost information; and
workload profile information;
where workload profile information includes one or more characteristics of:
(a) the request; and
(b) the state of the database system;
executing the request using the selected physical plan to produce results.

14. The system of claim 13 where selecting a plan to execute the request using the workload profile information includes:
using characteristics of the request including one or more of the following: (a) service level goals and priorities, and (b) application types.

15. The system of claim 13 where selecting a plan to execute the request using the workload profile information includes:
using characteristics of the state of the database system including one or more of the following:
(a) memory availability, (b) task availability, (c) disk availability, (d) CPU availability, and (e) lock granularity, (f) type of scan that is being run by the system for another request, and (g) request arrival rate.

16. The system of claim 13 where enumerating the logical plan into a plurality of physical plans includes consideration of one or more of the following:
types of joins in the request;
one or more access paths available for the tables;
join geographies; and
the order of execution of the joins in the request.

17. A system including:
a massively parallel processing system including:
one or more nodes;
a plurality of CPUs, each of the one or more nodes providing access to one or more CPUs;
a plurality of data storage facilities, each of the one or more CPUs providing access to one or more data storage facilities;
a process for optimizing the execution of a SQL request on a database system, the database system having a state, the state having characteristics and the request having characteristics, the SQL request having been parsed to create a logical plan, the logical plan having been enumerated into a plurality of physical plans, each of the plurality of physical plans having been costed using the current environmental and data demographics of the database system to produce cost information, the method including:
selecting one of the plurality of physical plans to execute the query using:
the cost information; and
workload profile information;
where workload profile information includes one or more characteristics of the request and the state of the database system.

18. The system of claim 17, the process further including:
executing the request using the selected physical plan to produce results.

19. A method for optimizing the execution of a SQL request on a database system, the database system having a state, the state having characteristics and the request having characteristics, the method including:
parsing the SQL request to create a logical plan;
enumerating the logical plan into a plurality of physical plans;
costing the plurality of physical plans using the current environmental and data demographics of the database system and workload profile information to produce cost information, where workload profile information includes one or more characteristics of:
(a) the request; and
(b) the state of the database system;
selecting one of the plurality of physical plans to execute the request using the cost information;
executing the request using the selected physical plan to produce results.
